(19) United States
(12) Patent Application Publication
(10) Pub. No.: US 2012/0234883 A1
(43) Pub. Date: Sep. 20, 2012

(54) REAR-MOUNTED BICYCLE CARRIER

(75) Inventors: Chris Sautter, Portland, OR (US); James Owen, Portland, OR (US); Richard Jeli, Milwaukie, OR (US)

(73) Assignee: Yakima Products, Inc., Beaverton, OR (US)

(21) Appl. No.: 13/226,366

(22) Filed: Sep. 6, 2011

Related U.S. Application Data
(60) Provisional application No. 61/379,887, filed on Sep. 3, 2010.

(51) Int. Cl. B60R 9/10; B60R 9/06

(52) U.S. Cl. 224/502; 224/488

(57) ABSTRACT

A versatile rack for carrying one or more bicycles on the rear of a vehicle includes two or more frame structures connected and coordinated through a pair of hubs. One of the frame structures has a pair of parallel arms equipped with saddle mounts and stabilizers for supporting and securing one or more bicycles.

### CROSS-REFERENCE TO RELATED APPLICATIONS

This application claims priority to U.S. Provisional Patent Application Ser. No. 61/379,887 filed Sep. 3, 2010, which is incorporated herein by reference in its entirety for all purposes.

The following U.S. patents and applications are incorporated by reference in their entirety: U.S. Pat. No. 4,830,250, U.S. Pat. No. 5,056,700, U.S. Pat. No. 5,259,542, U.S. Pat. No. 6,286,738, U.S. Pat. No. 6,840,418, U.S. Pat. No. 7,404,504, U.S. Pat. No. 7,975,888, and Ser. No. 11/198,891.

### INTRODUCTION

The popularity of recreational and competitive cycling has grown substantially in recent years. The numbers of different bike designs and configurations has also expanded exponentially. As a result, the demand for bicycle carriers to transport bikes of varying dimensions and designs, on cars and other vehicles, also has grown significantly. There are various types of vehicle-mounted bicycle carriers available. One type is mountable on a trunk (“trunk rack”) or other rear portion of a vehicle to carry one or more bicycles adjacent the rear of the vehicle. Typically, those carriers include support arms to support one or more bicycles. Trunk racks may be adaptable for mounting on the rear of vehicles that do not have a trunk, for example, a vehicle with a hatch back. Trunk racks are known for being lightweight, compact for storage, and easy to put on and take off vehicles of different shapes and sizes.

### SUMMARY

A bike rack frame is configured for mounting on a rear end of a vehicle. A rack includes first and second frame portions pivotally connected to each other via a pair of hub assemblies. Each frame structure has a frictional padded surface for contacting a vehicle. A third frame structure is U-shaped, and also pivotally connected to the hub assemblies. The third frame structure includes first and second arms, each arm having one or more saddle mounts and stabilizers for supporting a bicycle. The rack is also equipped with straps for securing the bike rack to the vehicle. Another rack configuration has two coordinated frame structures, each having a frictional padded surface for contacting a vehicle. One of the frame structures include first and second parallel arms having saddle mounts and stabilizers for supporting one or more bicycles.

### BRIEF DESCRIPTION OF THE DRAWINGS

FIG. 1 is a perspective view of a trunk rack mounted on the rear of a vehicle.

FIG. 2 is a cross section through a portion of the rack shown in FIG. 1.

FIG. 3 is a side view of the rack shown in FIG. 1.

FIG. 4 is a partial perspective view of a portion of the rack shown in FIG. 1.

FIG. 5 is an exploded perspective view of a saddle mount and anti-sway stabilizer from the rack shown in FIG. 1.

FIG. 6 is a side view of the saddle mount and the stabilizer shown in FIG. 5.

FIG. 7 is a perspective view of an alternative rack embodiment configured for mounting on the rear of a vehicle.

FIG. 8 is a side view of the rack shown in FIG. 7.

FIG. 9 is a partial cross-sectional view taken from the rack shown in FIG. 8.

FIG. 10 is a partial exploded view of a portion of the rack shown in FIG. 8.

### DETAILED DESCRIPTION

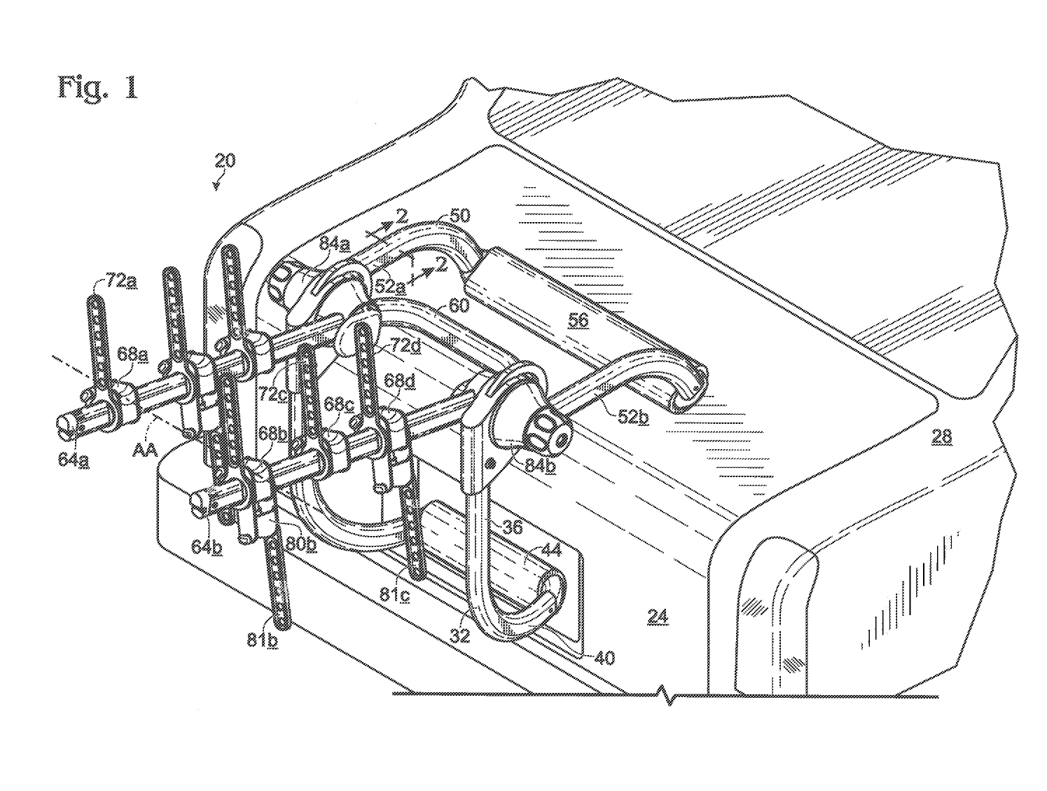

FIG. 1 shows rack 20 mounted on rear 24 of vehicle 28. Rack 20 includes first U-shaped rigid frame structure 32. Frame structure 32 has proximal straight portion 36 which curves and merges into distal straight portion 40. Distal straight portion 40 merges into straight foot portion 44. The other end of lower straight foot portion 44 is connected to straight and curved frame portions identical to those previously described. Lower straight foot portion 44 is padded and configured for contacting rear portion 24 of vehicle 28.

Second U-shaped frame structure 50 also includes matching lateral frame components 52a and 52b. Each of frame portions 52a and 52b include a straight portion which curves, then straightens before merging into upper straight foot portion 56. Upper straight foot portion 56 is padded and configured for contacting rear portion 24 of vehicle 28.

A third U-shaped frame structure 60 is configured for supporting bicycles. Frame structure 60 includes a pair of arms 64a and 64b which are preferably parallel to each other. As shown in FIG. 1, each arm 64a, 64b is equipped with three saddle mounts, for example, 68b-d on arm 64b. Each saddle mount, for example, 68a, is intended to be used in conjunction with a saddle mount on the other arm, for example 68b, to cooperatively secure the top tube of a bicycle. For each pair of saddle mounts 68a and 68b, one of the saddle mounts 68b is coupled with a stabilizer, i.e., anti-sway device 80b for preventing a bike from swinging about an axis AA connecting corresponding saddle mounts on arms 64a, 64b.

First, second and third U-shaped frame structures are connected to each other via hubs 84a and 84b. FIG. 3, discussed below, shows how hubs 84a and 84b may be used to adjust relative positions of the U-shaped frame structures for adapting rack 20 to different vehicle shapes. For example, appropriate hub assemblies may be seen in U.S. Pat. No. 6,840,418 which is hereby incorporated by reference.

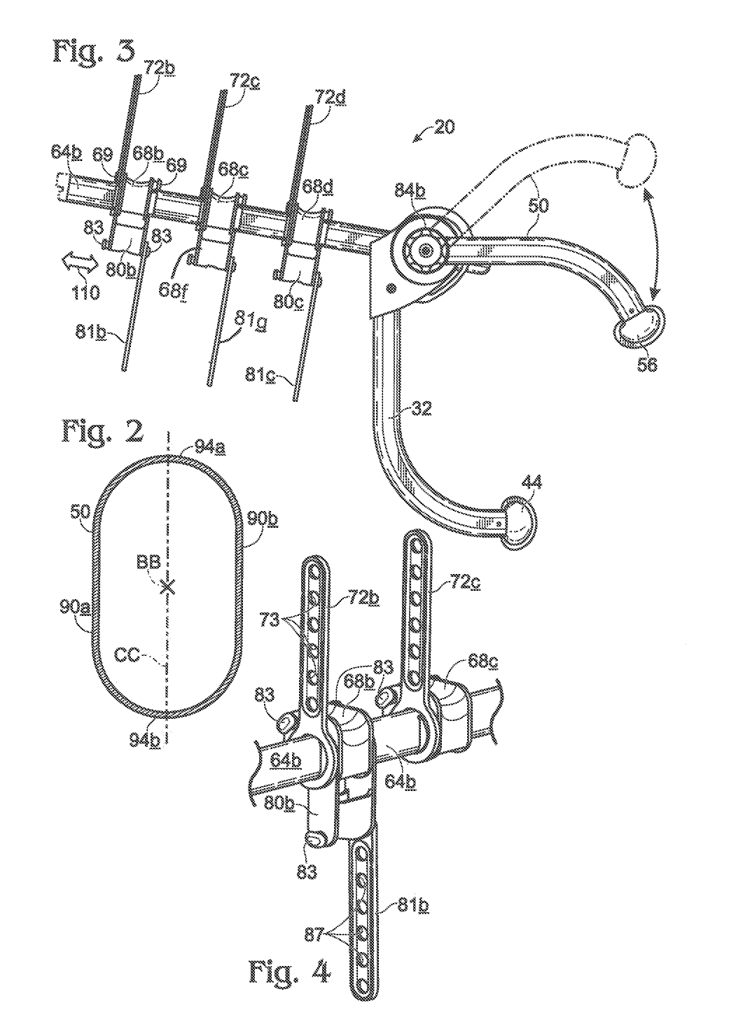

FIG. 2 shows a cross section through second U-shaped frame structure 50, as shown in FIG. 1. The cross-sectional view of FIG. 2 shows the tubular shape which is generally consistent throughout the first, second and third U-shaped frame structures. As shown in FIG. 2, frame structure 50 has a tubular shape which is a modified oval or “track shaped”. This shape is characterized by opposing straight, flat, or planar wall portions 90a, 90b and opposing curved wall portions 94a, 94b. In a preferred tube shape the track shape approximately 1.0-inch wide and 1.75-inches high. Frame structure 50 has a core access BB which is perpendicular to the plane of the cross section shown in FIG. 2. Elongate axis CC is perpendicular to core access BB, parallel to and equidistant from straight wall portions 90a, 90b, and bisecting curved wall portions 94a, 94b. Referring back to FIG. 1, arms 64a and 64b are formed from a tube having a cross section, as shown in FIG. 2, with elongate access CC oriented vertically, i.e., in the gravitational direction, or generally perpendicular to the direction of vehicle travel.

FIG. 3 shows a side view of rack 20. Upper (second) U-shaped frame structure 50 is shown pivoted to a second position in dashed lines for accommodating a different vehicle shape. Frame structures 32, 50 each have a curvature, as shown in FIG. 3, characterized by an inside radius of approximately six inches. Rack 20 has arm 64b for supporting bicycles. Arm 64b is equipped with three saddle mounts 68b, 68c and 68d.

Each saddle mount has a trough contoured to support a bicycle frame tube in a desired location. Each of saddle mounts 68b, 68c and 68c has a strap 72b, 72c and 72d mounted on arm 64b adjacent to the respective saddle mount for lashing and securing a bicycle tube to the respective saddle mount. Each of saddle mounts 68b, 68c and 68d also have knobs or pegs 69. Each of straps 72b, 72c and 72d have a series of apertures, 73 in FIG. 4. When a bicycle is mounted on a given saddle mount, strap 72b may be lashed around the tube then connected to peg 69 by inserting the peg through one of apertures 73 in strap 72b. As shown in FIG. 3, two of the saddle mounts 68b and 68d are additionally coupled with stabilizers or anti-sway devices 80b and 80c for preventing bicycles from swinging in the direction of arrow 110. Each of the stabilizers has one or more pegs or posts 83 for mounting straps such as strap 81b, 81c, and for lashing the strap around the downtube of a bicycle by securing peg 83 through one of the apertures 87 in strap 81b. Stabilizer 68f and strap 81g from arm 64a (not shown in FIG. 3) are also visible in FIG. 3.

FIG. 4 shows a partial enlarged view of arm 64b and two saddle mounts 68b, 68c mounted on the arm. Each of saddle mounts 68b and 68c are positioned along arm 64b for receiving the top tubes of a pair of bicycles. Each of saddle mounts 68b and 68c is positioned to correspond with another saddle mount similarly positioned on the other arm 64a, as shown in FIG. 1. Corresponding saddle mounts on arms 64a and 64b form a pair of corresponding saddle mounts configured to cooperatively secure a single bicycle. Among each pair of corresponding saddle mounts, one of the saddle mounts is coupled with a stabilizer. Accordingly, a bicycle may be secured by placing the bicycle with the top tube resting on the pair of saddle mounts with a downtube, for example, a tube descending from a bicycle seat, adjacent to the stabilizer. Generally, a single stabilizer for each pair of corresponding saddle mounts is sufficient.

As shown in FIG. 4, each of saddle mounts 68b, 68c has strap 72b and 72c, respectively, mounted adjacent to the saddle mount. Each of straps 72b, 72c have apertures 73 for securing the strap to an appropriate peg 83 on the opposite side of the respective saddle mount. Saddle mount 68b also is coupled with stabilizer 80b. Stabilizer 80b has strap 81b which is provided with apertures 87. Stabilizer 80b may be secured to the downtube of the bicycle by lashing strap 81b around the downtube and inserting peg 83 through one of apertures 87.

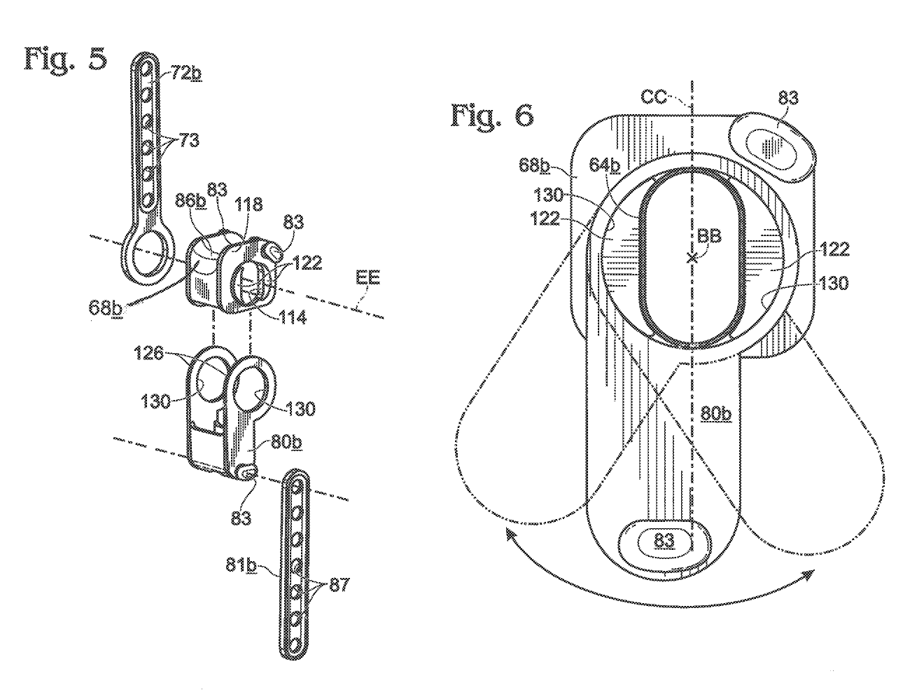

FIG. 5 shows an exploded view of saddle mount 68b, strap 72b, stabilizer 80b, and stabilizer strap 81b. Saddle mount 68b has an aperture 114 which has a track shape conforming to the shape and dimension of arm 64b, as also shown in FIG. 2. Saddle mount 68b has a side wall 118 and a pair of ears 122 which protrude beyond wall 118. Ears 122 each have curved outer surfaces which are on the same circular path. Another pair of ears such as 122 are provided on the other side of saddle mount 68b (not shown) in FIG. 5. Stabilizer 80b has a pair of side struts 126. Each strut 126 has a circular aperture 130 which has a diameter just slightly larger than the diameter of a circle defined by the outer curved surfaces of ears 122. Stabilizer 80b is coupled with saddle mount 68b by mounting struts 126 on ears 122 on both sides of saddle mount 68b. It can be seen from FIG. 5 that the resulting assembly results in a saddle mount which is restricted from rotating around arm 64b due to the noncircular shape of arm 64b and the corresponding noncircular aperture of saddle mount 68b. In contrast, stabilizer 80b is permitted to rotate around axis EE due to the circular shape of apertures 130 in struts 126 of stabilizer 80b, and the corresponding circular path defined by the outer curved surfaces of ear 122.

FIG. 6 shows a side view of saddle mount 68b mounted on arm 64b. Saddle mount 68b is restricted from rotating around core axis BB due to the noncircular shape, i.e., track shape, of arm 64b, and corresponding noncircular aperture of saddle mount 68b. In contrast, stabilizer 80b is shown rotating, in dashed lines, around core axis BB. Stabilizer 80b is capable of rotation around core axis BB because it is mounted on ears 122 which have outer surfaces 130 defining a circular path having a diameter approximately equal to the long axis of the track shape of arm 64b, and approximately equal to the diameter of the aperture 130 in struts 126 of stabilizer 80b.

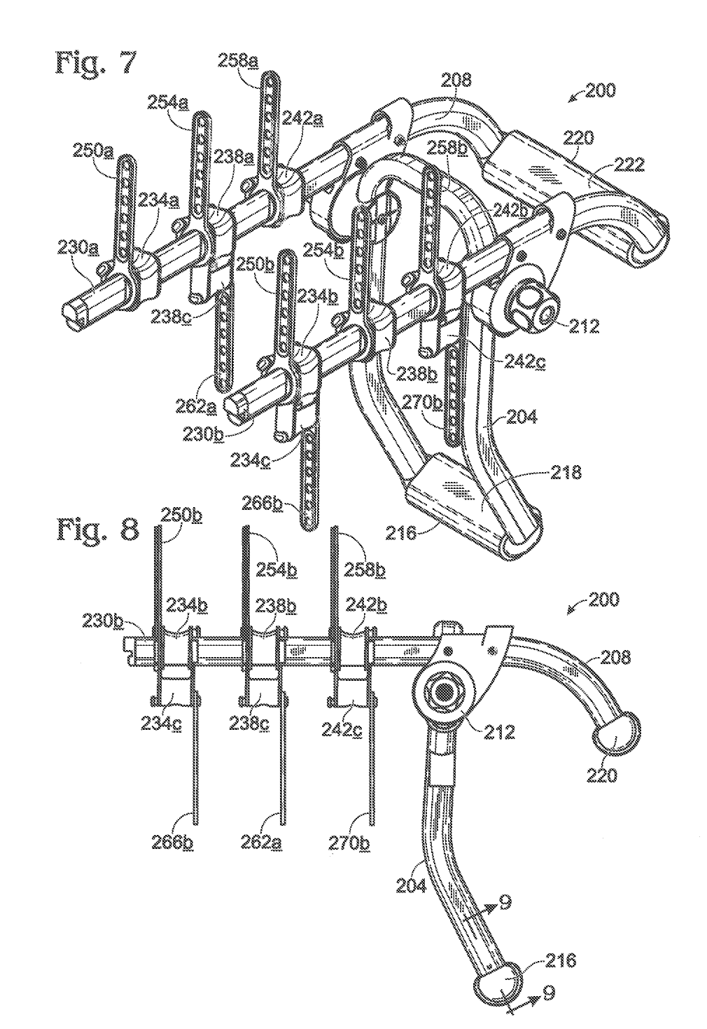

FIG. 7 shows an alternative rack embodiment configured for mounting on the rear of a vehicle. Rack 200 includes hoop-shaped frame structure 204 and U-shaped frame structure 208 which are joined together via hubs 212. Hubs 212 are configured to allow pivoting of U-shaped frame structure 208 relative to hoop-shaped frame structure 204 between a storage position and various use positions. Hubs 212 also allow the frame structures to be adapted to conform to various vehicle designs. In general, the goal is to lock in the orientation of the two frame structures so that arms 230a and 230b of U-shaped frame structure 208 extend in a generally horizontal, sometimes slightly upward extending orientation from the rear of the vehicle. Hoop-shaped frame structure 204 has a straight foot portion 216 which includes pad 218 configured for contacting a lower exterior surface region of a vehicle. Similarly, U-shaped frame structure 208 has upper straight foot portion 220 equipped with pad or cushion 222 for contacting an upper exterior surface region of a vehicle. Each of arms 230a, 230b is equipped with three saddle mounts, 234a, 238a, 242a and 234b, 238b and 242b, respectively. Although, the racks shown in the drawings, and discussed so far, are configured for carrying three bicycles, it should be appreciated that other numbers of saddle mounts and arm dimensions and configurations may be used to alter the capacity of the rack to carry different numbers of bicycles. Saddle mount 234a on arm 230a is positioned to correspond with saddle mount 234b on arm 230b for securing the same frame component of a bicycle. Saddle mount 238a is positioned to correspond with saddle mount 238b on arm 230b for securing the same frame component of a bicycle. Similarly, saddle mount 242a on arm 230a is positioned to correspond with saddle mount 242b on arm 230b for carrying the same frame component of a bicycle. As shown in FIG. 7, each pair of corresponding saddle mounts has one saddle mount which is additionally coupled with a stabilizer. For example, saddle mount 234b is coupled with stabilizer 234c. Saddle mount 238a is coupled with stabilizer 238c. Saddle mount 242b is coupled with stabilizer 242c. Each saddle mount has a strap mounted on one side, the strap having apertures for fastening the strap to a peg or post on the opposite side of the respective saddle mount. For example, saddle mount 234a has strap 250a. Saddle mount 238a has strap 254a. Saddle mount 242a has strap 258a. Saddle mount 234b has strap 250b. Saddle mount 238b has strap 254b. Saddle mount 242b has strap 258b. Additionally, each stabilizer has a strap connected on one side of the stabilizer and a post or peg on the opposite side of the stabilizer for fastening the strap around a downtube of a bicycle. For example, stabilizer 238c has strap 262a. Stabilizer 234c has strap 266b. Stabilizer 242c has strap 270b.

Each of the saddle mounts and stabilizers on rack 200, as shown in FIG. 7, have the same general configuration illustrated in FIGS. 5 and 6. Accordingly, saddle mounts 234a, 238a, 242a, 234b, 238b, and 242b are restricted from rotating around bars 230a and 230b, respectively. In contrast, stabilizers 238c, 234c and 242c are mounted on ears having curved external surfaces which allow the stabilizers to rotate around arms 230a and 230b. Rotational freedom of the stabilizers relative to the saddle mount allows the rack to be adaptable for bicycles having different frame geometries.

FIG. 8 shows a side view of rack 200. Hoop-shaped frame structure 204 is assembled with U-shaped frame structure 208 via hubs 212. Frame structure 204, 208 each have a curvature characterized by an inside radius of approximately six inches. Arm 230b includes saddle mounts 234b, 238b and 242b, and stabilizers 234c and 242c and associated straps, as described already with respect to FIG. 7. Hoop-shaped frame structure 204 has lower straight foot portion 216 which is padded for contacting a lower rear portion of the vehicle. U-shaped frame structure 208 has upper straight foot portion 220 which is also padded for contacting an upper rear portion of the vehicle.

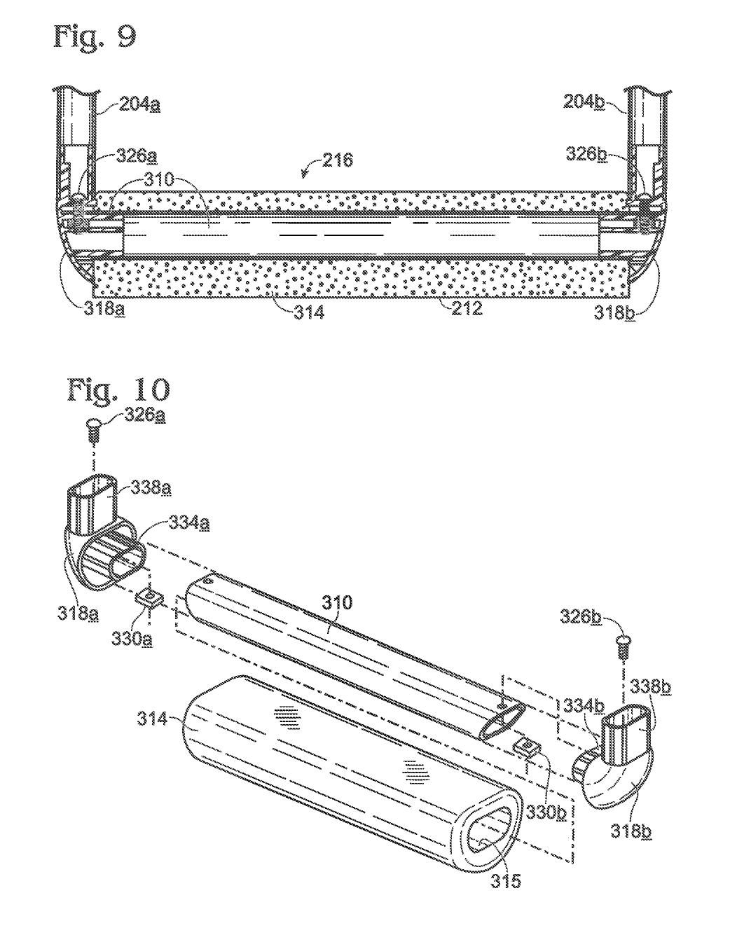

FIG. 9 shows a cross section through foot portion 216 in FIG. 8. Foot portion 216 includes transverse rigid tube 310. Foam cushion 314 covers tube 310. Tube 310 is secured to leg members 204a, 204b via elbow pieces 318a, 318b. Elbows 318a, 318b are secured to tube 310 by screws 326a, 326b. FIG. 10 shows an exploded perspective view of the foot assembly shown in FIG. 9. As shown in FIG. 10, elbow pieces 318a, 318b each have a pair of inner tube portions oriented at right angles for insertion in respective leg portions and transverse tube member 310. For example, elbow member 318a has inner tube portion 334a configured for insertion at one end of transverse tube 310. Elbow piece 318a also has inner tube portion 338a for insertion into leg portion 204a of hoop-shaped frame structure 204. Screw 326a engages nut 330a to hold the assembly together. Similarly, elbow member 318b has inner tube portion 334b configured for insertion into the opposite end of transverse tube 310. Elbow piece 318b also has inner tube portion 338b which is configured for insertion into leg 204b. Screw 326b and nut 330b are provided for securing the elbow assembly.

Referring back to FIG. 9, elbow members 318a and 318b provide a flush transition between the outer surface of the elbow and the leg portion. The elbow members also make it possible to achieve a sharper cleaner perpendicular turn from the foot member to the leg portion of the frame structure. This allows the pad to extend continuously from leg 204a to leg 204b and to provide desirable side-to-side stability of the rack in use. As shown in FIG. 10, transverse tube 310 has a track-shaped cross section as described above with respect to the main frame portions of the bicycle racks (FIG. 2). Pad 314 has an aperture 315 which is also track shaped to complement the outer shape and dimension of transverse tube 310. Accordingly, pad 314, when mounted on transverse tube 310, is not generally capable of rotating around the transverse tube. As shown in FIG. 9, pad or cushion 314 has a variable thickness, with its thickest portion, for example, approximately 0.5- to 1.0-inch (preferably 0.85-inch) thick, being positioned on the lower side of the frame which generally corresponds to the part of the foot which contacts a surface of a vehicle. The opposite side of the pad is thinner, for example, 0.25- to 0.75-inch (preferably 0.5-inch). The pad may be made of a variety of materials provided that it has good compressibility, resiliency, and frictional characteristics. For example, ethylene vinyl acetate (EVA) is a suitable material for this purpose. It should be appreciated that a pad may take a number of different forms. For example, numerous pads may be used instead of a single pad. In the embodiment shown in FIGS. 9 and 10, pad 314 extends continuously from leg 204a to 204b. Elbows 318a and 318b provide an inset for pad 314 providing a clean, efficient, aesthetic look.

The various structural members disclosed herein may be constructed from any suitable material, or combination of materials, such as metal, plastic, nylon, plastic, rubber, or any other materials with sufficient structural strength to withstand the loads incurred during use. Materials may be selected based on their durability, flexibility, weight, and/or aesthetic qualities. It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

Inventions embodied in various combinations and subcombinations of features, functions, elements, and/or properties may be claimed through presentation of new claims in a related application. Such new claims, whether they are directed to a different invention or directed to the same invention, whether different, broader, narrower or equal in scope to the original claims, are also regarded as included within the subject matter of the inventions of the present disclosure.

We claim:

1. A rack for carrying a bicycle comprising
a rigid frame structure including an upper straight segment configured for contacting an upper rear region of a vehicle, a lower straight segment configured for contacting a lower rear region of a vehicle, a pair of arms extending in parallel and equipped for supporting and securing a bicycle frame, wherein at least a portion of the frame structure has a track shape characterized by a core axis, a cross section perpendicular to the core axis, the cross section having a pair of opposing planar walls, a pair of opposing curved walls, and an elongate axis equidistant from and parallel to the planar walls and perpendicular to the central axis of the frame structure.

2. The rack of claim 1, wherein substantially the entire frame structure has the track shape.

3. The rack of claim 1, wherein the arms have the track shape, the elongate axis being oriented substantially vertically relative to a horizontal direction of vehicle travel.

4. The rack of claim 1, wherein the upper straight segment has the track shape and a cushion covering substantially the entire upper straight segment.

5. The rack of claim 1, wherein the lower straight segment has the track shape and a cushion covering substantially the entire lower straight segment.

6. The rack of claim 1, wherein the upper and lower straight segments and pair of arms are coordinated through a pair of hub assemblies.

7. The rack of claim 3, wherein each arm has at least one saddle mount, each saddle mount having track shaped aperture dimensioned to compliment the track shape of the respective arm.

8. The rack of claim 7, wherein each saddle mount has a pair of curved side ears adjacent the planar walls of the respective arm, the curved side ears and curved walls of the arm creating a circular interface for mounting a strap or a rotatable anti-sway device.

9. The rack of claim 8, further comprising
an anti-sway device mounted on the circular interface adjacent one of the saddle mounts, the anti-sway device being capable of pivoting around the core axis of the arm, and having a strap for binding a portion of a bicycle frame to the anti-sway device.

10. A rack for carrying a bicycle comprising
a rigid frame structure including an upper straight segment configured for contacting an upper rear region of a vehicle, a lower straight segment configured for contacting a lower rear region of a vehicle, and a pair of arms extending in parallel and equipped for supporting and securing a bicycle frame, wherein at least one of the upper and lower straight segments spans from a first lateral tube portion to a second lateral tube portion, the one straight segment being connected to each lateral tube portion via an elbow piece creating a perpendicular orientation between the one straight segment and the respective lateral tube portions.

11. The rack of claim 10, wherein at least one of the straight segments includes a rigid foot tube having a track shape characterized by a core axis, a cross section perpendicular to the core axis, the cross section having a pair of opposing planar walls, a pair of opposing curved walls, and an elongate axis equidistant from and parallel to the planar walls and perpendicular to the central axis of the frame structure.

12. The rack of claim 11, further comprising at least one foam tube mounted on the foot tube, having a track shaped aperture dimensioned to compliment the track shape of the foot tube.

13. The rack of claim 12, wherein the foam tube runs continuously from the first lateral tube portion to the second lateral tube portion.

14. A rack for carrying a bicycle comprising
a rigid frame structure including an upper straight segment configured for contacting an upper rear region of a vehicle, a lower straight segment configured for contacting a lower rear region of a vehicle, and a pair of arms extending in parallel and equipped for supporting and securing a bicycle frame, wherein at least one of the upper and lower straight segments spans from a first lateral tube portion to a second lateral tube portion, the one straight segment including a tube having a track shape characterized by a core axis, a cross section perpendicular to the core axis, the cross section having a pair of opposing planar walls, a pair of opposing curved walls, and an elongate axis equidistant from and parallel to the planar walls and perpendicular to the central axis of the frame structure.

15. The rack of claim 14, further comprising at least one foam tube mounted on the foot tube, having a track shaped aperture dimensioned to compliment the track shape of the foot tube.

16. The bike rack of claim 14, wherein the foam tube runs continuously from the first lateral tube portion to the second lateral tube portion.

17. A rack for carrying a bicycle comprising
a rigid frame structure including an upper straight segment configured for contacting an upper rear region of a vehicle, a lower straight segment configured for contacting a lower rear region of a vehicle, and a pair of arms extending in parallel and equipped for supporting and securing a bicycle frame, wherein at least one of the upper and lower straight segments has a foam pad spanning continuously from a first lateral tube portion to a second lateral tube portion.

18. The rack of claim 17, wherein the foam pad has a track shaped aperture characterized by a core axis, a cross section perpendicular to the core axis, the cross section having a pair of opposing planar walls, a pair of opposing curved walls.

19. A rack for carrying a bicycle comprising
a rigid frame structure including an upper straight segment configured for contacting an upper rear region of a vehicle, a lower straight segment configured for contacting a lower rear region of a vehicle, a pair of arms extending in parallel and equipped for supporting and securing a bicycle frame, each of the arms having a track shape characterized by a core axis, a cross section perpendicular to the core axis, the cross section having a pair of opposing planar walls, a pair of opposing curved walls, and an elongate axis equidistant from and parallel to the planar walls and perpendicular to the central axis of the frame structure, wherein the arms have upper surfaces that lie in the same plane, the elongate axis being perpendicular to the plane.

20. The rack of claim 19, wherein each arm has at least one saddle mount, each saddle mount having track shaped aperture dimensioned to compliment the track shape of the respective arm.

21. The rack of claim 19, wherein each saddle mount has a pair of curved side ears adjacent the planar walls of the respective arm, the curved side ears and curved walls of the arm creating a circular interface for mounting a strap or a rotatable anti-sway device.

22. The rack of claim 19, further comprising
an anti-sway device mounted on the circular interface adjacent one of the saddle mounts, the anti-sway device being capable of pivoting around the core axis of the arm, and having a strap for binding a portion of a bicycle frame to the anti-sway device.
